(19) United States
(12) Patent Application Publication
(10) Pub. No.: US 2018/0372525 A1
(43) Pub. Date: Dec. 27, 2018

(54) METHOD FOR DETECTING THE LEVEL OF A FLUID IN A LIQUID AND/OR SOLID STATE IN A TANK AND ASSOCIATED SYSTEM

(71) Applicant: Plastic Omnium Advanced Innovation and Research, Bruxelles (BE)

(72) Inventors: Yacouba SANOGO, Compiegne (FR); Damien CORNANGUER, Vancouver (CA)

(73) Assignee: Plastic Omnium Advanced Innovation and Research, Bruxelles (BE)

(21) Appl. No.: 15/777,423

(22) PCT Filed: Nov. 21, 2016
(86) PCT No.: PCT/EP2016/078249

§ 371 Date: May 18, 2018

(30) Foreign Application Priority Data
Nov. 20, 2015 (FR) 1561209
Feb. 3, 2016 (FR) 1650840

(51) Int. Cl. G01F 23/26; G01F 23/00

(52) U.S. Cl. CPC G01F 23/265; G01F 23/266; G01F 23/0076

(57) ABSTRACT

A method is proposed for detecting the level of a fluid in a tank by means of a capacitive probe, the probe comprising a column of capacitive elements, each capacitive element being associated with a given level in the tank. The method comprises the following steps consisting in, for each capacitive element: obtaining a value representative of the capacitance of the capacitive element; obtaining a compensation value depending on a piece of temperature information; calculating a compensated value from the value representative of the capacitance of the capacitive element and from the compensation values; detecting the presence of the fluid at the level associated with the capacitive element, by comparing the compensated value to a preset detection threshold.

The present invention relates to a method for detecting the level of a fluid in a liquid and/or solid state in a tank by means of a capacitive sensor. More particularly, the invention is used for measuring a level of fuel in a motor vehicle fuel tank. The invention is also used for measuring a level of a urea aqueous solution in a motor vehicle urea tank.

Many devices have been proposed thus far for measuring the level of a liquid in a tank and, in particular, in a fuel tank of a motor vehicle.

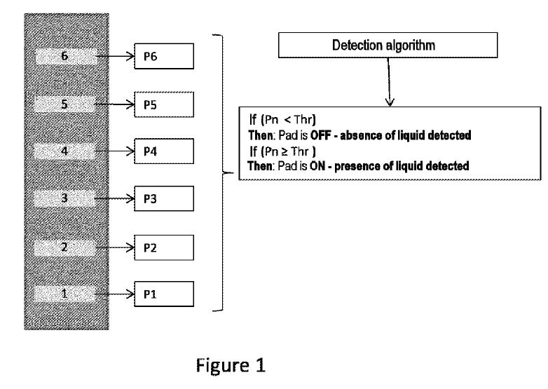

A known measuring device is based on the use of a capacitive sensor. Generally, such a sensor comprises a column of capacitive elements. The capacitive elements are placed above one another at a regular interval. Each capacitive element is therefore associated with a given level in the tank. Generally, each capacitive element provides information or a value representing the capacitance value thereof. Generally, this information is a count number representing the number of charging and discharging phases of the capacitive element during a predetermined period of time. This count number is used to detect the presence or the absence of liquid at the given level with which the capacitive element is associated. FIG. 1 illustrates a known algorithm for detecting the level of a liquid in a tank, using the values provided by the capacitive elements. In this known algorithm, the value (P1, P2, P3, P4, P5 and P6) provided by each of the capacitive elements (1, 2, 3, 4, 5 and 6) is compared with a detection threshold. The capacitance value of each capacitive element can vary as a function, for example, of the temperature, of the dielectric constant of the fluid in which the capacitive elements change and of the thickness of the plastic in which the capacitive elements are integrated. By ignoring these variations, as does this conventional algorithm of the prior art, the determination of the level of liquid in the tank cannot be robust.

One of the aims of the invention is, therefore, to propose a method for detecting the level of a fluid (in a liquid and/or solid state) in a tank by means of a capacitive sensor allowing robust determination of the level of fluid in the tank.

Consequently, a specific embodiment of the invention proposes a method for detecting the level of a fluid (in a liquid and/or solid-state) in a tank by means of a capacitive sensor, the sensor comprising a column of capacitive elements, each capacitive element being associated with a given level in the tank. The method comprises the following steps consisting in, for each capacitive element:
obtaining a value representing the capacitance of the capacitive element;
obtaining a compensation value as a function of temperature information;
calculating a compensated value from the value representing the capacitance of the capacitive element and from the compensation value;
detecting the presence of the fluid at the level associated with the capacitive element, by comparing the compensated value with a predetermined detection threshold.

More robust measuring of the level of fluid in the tank can thus be achieved since there is automatic compensation of the changes due to the variation in the temperature and the variation in the dielectric constant of the fluid is taken into account in the all-or-nothing aspect of the capacitive sensor.

In a specific embodiment, the sensor comprises at least one thermistor that can provide said temperature information.

Advantageously, the method comprises the following steps consisting in, for a current capacitive element at a current level and a following higher capacitive element at a following higher level:
calculating a value difference between the value representing the capacitance of the current capacitive element and the value representing the capacitance of the following higher capacitive element;
using said calculated value difference in order to calculate said compensated value.

In an advantageous embodiment, the method further comprises the following steps consisting in:
detecting the presence of a temperature gradient along the sensor and determining a compensation coefficient as a function of said temperature information;
calculating a compensated value difference by applying the compensation coefficient to said calculated value difference;
using said compensated value difference in order to calculate said compensated value.

Advantageously, the method comprises the following steps consisting in:
detecting an event indicating a need to adjust said detection threshold as a function of the value representing the capacitance of the capacitive element and a predetermined count error tolerance;
adjusting said detection threshold with the value representing the capacitance of the capacitive element.

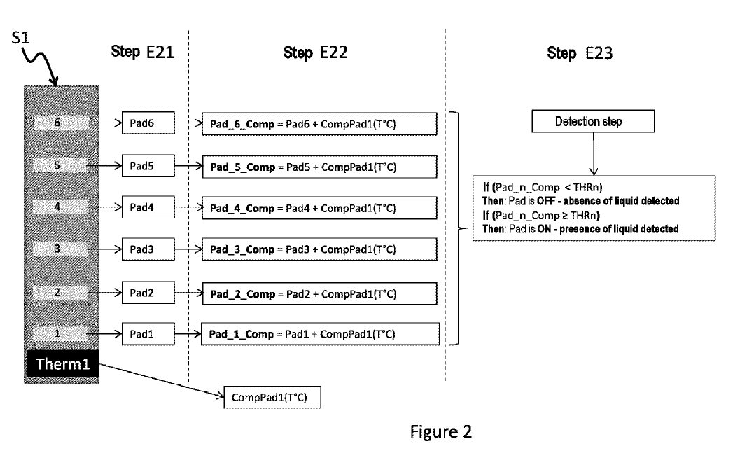

FIG. 2 illustrates an algorithm for detecting the level of a fluid in a tank according to a first specific embodiment of the invention. In this exemplary embodiment, the capacitive sensor S1 comprises six capacitive elements (1, 2, 3, 4, 5 and 6) and a thermistor (TH1) positioned in proximity to the capacitive element 1. Of course, in another embodiment, the capacitive sensor can comprise a greater number of capacitive elements. The thermistor (Therm1) is configured to measure the temperature in proximity to the capacitive element 1. Of course, in another embodiment, the capacitive sensor can comprise several thermistors. In a first other exemplary embodiment, the capacitive sensor can comprise a first thermistor positioned in proximity to the capacitive element 1 and a second thermistor positioned in proximity to the capacitive element 6. With such a configuration, it is possible to use the information provided by the first and second thermistors in order to detect the presence of a temperature gradient along the sensor. In a second other exemplary embodiment, the capacitive sensor can comprise a thermistor positioned in proximity to each capacitive element.

In the step E21, a value representing the capacitance of each of the capacitive elements is obtained. In a preferred embodiment, in the step E21 a count number (Pad₁, Pad₂, Pad₃, Pad₄, Pad₅ and Pad₆) is obtained for each capacitive element, which count number represents the number of charging and discharging phases of the capacitive element.

In the step E22, the temperature in proximity to the capacitive element 1 is obtained by means of the thermistor (Therm1) and a compensation value (CompPad1(T° C.)) is determined by using the measured temperature and a previously generated correlation table. This correlation table can be obtained in a theoretical or experimental manner. Then, for each capacitive element, a compensated value (or calibrated value) is calculated in the following manner:

Pad_n_Comp=Padₙ+CompPad1(T° C.) (eq. 1)

n being the number of the capacitive element 1, 2, 3, 4, 5 or 6.

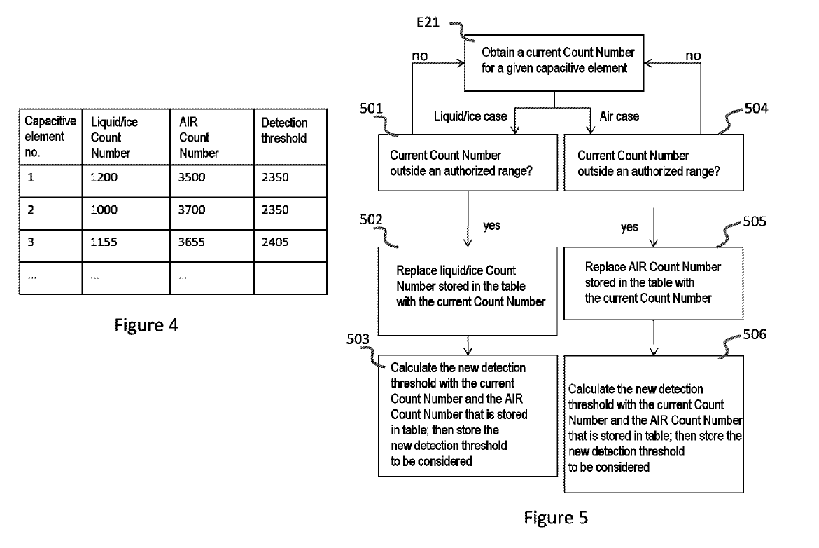

In the step E23, each compensated value is compared with a predetermined detection threshold (THRn). Thus, for a capacitive element “n”, if the compensated value (Pad_n_Comp) is higher than or equal to the detection threshold (THRn), then the presence of the fluid (which can be in a liquid and/or solid (i.e. ice) state) at the given level associated with the capacitive element “n” is detected (namely, is concluded), otherwise it is concluded that the capacitive element “n” is in air. In a specific embodiment, the predetermined detection threshold can be the same for all of the capacitive elements. In another specific embodiment illustrated in FIG. 4, the predetermined detection threshold can be different from one capacitive element to another capacitive element. FIG. 4 illustrates a count table. In the example of FIG. 4, the capacitive element 1 is calibrated such that it indicates a count number of “1200” when it is in contact with liquid or ice, and it indicates a count number of “3500” when it is in air (i.e. not in contact with liquid or ice). The capacitive element 3 is calibrated such that it indicates a count number of “1155” when it is in contact with liquid or ice, and it indicates a count number of “3655” when it is in air (i.e. not in contact with liquid or ice). In this example, a detection threshold is set at 2350 (namely (1200+3500)/2) for the capacitive element 1 and a detection threshold is set at 2405 (namely (1155+3655)/2) for the capacitive element 3.

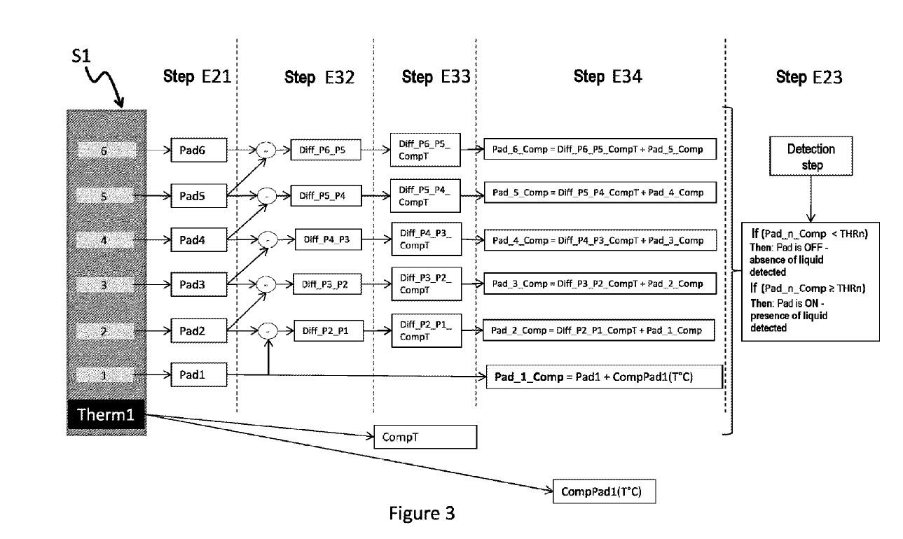

FIG. 3 illustrates an algorithm for detecting the level of a fluid in a tank according to a second specific embodiment of the invention. The second embodiment of FIG. 3 differs from the first embodiment described above with reference to FIG. 2 in that it implements steps E32, E33 and E34 instead of the step E22. The steps E32, E33 and E34 are described hereafter. The steps E21 and E23 of the algorithm of FIG. 3 are identical to the steps E21 and E23 of the algorithm of FIG. 2, and are therefore not described again hereafter.

In the step E32, the value difference between two consecutive capacitive elements (i.e. between a current capacitive element at a current level and a following higher capacitive element at a following higher level) is calculated. This advantageously makes it possible to reduce the effect of the common mode (i.e. any disruption of the measurement common to two capacitive elements) due, for example, to the thickness of the plastic or to the temperature gradient along the sensor. Thus, for each of the capacitive elements 2, 3, 4, 5 and 6, a value difference (Diff_Pₙ_{_}Pₙ₋₁) is calculated in the following manner:

Diff_Pₙ_{_}Pₙ₋₁=Padₙ−Pₙ₋₁ (eq. 2)

n being the number of the capacitive element 2, 3, 4, 5 or 6.
In the step E33, the temperature in proximity to the capacitive element 1 is obtained by means of the thermistor (Therm1) and the presence or the absence of a temperature gradient along the sensor is detected from the measured temperature. If the presence of a temperature gradient is detected, then a compensation coefficient (CompT) is determined by using the measured temperature and a theoretical relation (curve, table, formula, etc.), resulting from the literature, preferably validated experimentally. Alternatively, this relation can be generated experimentally on models and/or prototypes. Then, for each capacitive element, a compensated value difference (Diff_Pₙ_{_}Pₙ₋₁_{_}CompT) is calculated by applying the compensation coefficient (CompT) to the value difference calculated in the step E32. Then, the process moves onto the step E34.

In the step E34, the temperature in proximity to the capacitive element 1 is obtained by means of the thermistor (Therm1) and a compensation value (CompPad1(T° C.)) is determined by using the measured temperature and a previously generated correlation table. This correlation table can be obtained theoretically or experimentally. Then, for the capacitive element 1, a compensated value is calculated in the following manner:

Pad_1_Comp=Pad1+CompPad1(T° C.) (eq. 3)

Then, for each of the capacitive elements 2, 3, 4, 5 and 6, a compensated value is calculated in the following manner:

Pad_n_Comp=Diff_Pₙ_{_}Pₙ₋₁_{_}CompT+Pad_n−1_Comp (eq. 4)

n being the number of the capacitive element 2, 3, 4, 5 or 6.

In the step E33, when the absence of a temperature gradient is detected, the compensated value for each of the capacitive elements 2, 3, 4, 5 and 6 is calculated in the following manner:

Pad_n_Comp=Diff_Pₙ_{_}Pₙ₋₁+Pad_n−1_Comp (eq. 5)

n being the number of the capacitive element 2, 3, 4, 5 or 6.

The invention also relates to a system for detecting a level of liquid in a tank comprising:
a capacitive sensor, the sensor comprising a column of capacitive elements, each capacitive element being associated with a given level in the tank;
processing unit configured to carry out the following steps, for each capacitive element:
obtaining a value representing the capacitance of the capacitive element;
obtaining a compensation value as a function of temperature information;
obtaining a compensated value from the value representing the capacitance of the capacitive element and from the compensation value;
detecting the presence of liquid by comparing the compensated value with a predetermined detection threshold.

In an advantageous embodiment, the detection threshold (THRn) used in the step E23 (described above with respect to FIGS. 2 and 3) can be dynamically adjusted to take into account the ageing of the capacitive elements and the variation in temperature in proximity to the capacitive element 1. Consequently, the value representing the capacitance of the capacitive element 1 can be taken as a reference in order to perform this dynamic adjustment.

FIG. 5 illustrates a flow diagram of an example for implementing dynamic adjustment of the detection threshold(s) (THRn) used in the method according to the invention. In an advantageous embodiment, this dynamic adjustment can be performed following the step E21 (described above with reference to FIGS. 2 and 3).

In the step E21, a current count number is obtained for each capacitive element. In the example of FIG. 4, the capacitive element 1 is associated with a detection threshold of 2350. For example, in the step E21, the capacitive element 1 indicates a current account number of “1500”. The current count number is less than the detection threshold, and this therefore indicates a case of potential contact with liquid or ice and the process moves onto the step 501.

In the step 501, it is checked if the current count number is located within or outside an authorized range. In the example of FIG. 4, the capacitive element 1 is calibrated such that it indicates a count number of “1200” when it is in contact with liquid or ice. For example, the count error tolerance is set at ±5% of 1200. Thus, in the step 501, it is detected that the current count number (1500) is located outside the authorized range of 1140-1260. This event therefore indicates a need to adjust the detection threshold. The process then moves onto the step 502.

In the step 502, the count number of “1200” is replaced in the count table with the current count number of “1500”.

Then, in the step 503, the new detection level is calculated with the current count number of “1500” and the count number of “3500” (indicating contact with air). The new threshold is 2500 (namely (1500+3500)/2) for the capacitive element 1.

A person skilled in the art will have no difficulty in understanding that the principle of the steps 501, 502 and 503, that is described above, can be used for the steps 504, 505 and 506.

Advantageously, such a dynamic adjustment of the detection threshold is performed for each capacitive element of the capacitive sensor.

Advantageously, the method of the invention further comprises one or more steps for determining the state of the fluid at the various levels of the tank, with the sensor in which each capacitive element is associated with a given level in the tank.

Thanks to combinable data, resulting from the dielectric properties of the fluid in which the sensor is submerged and data known for the use of the capacitive elements of the sensor, it is possible to establish a thermal model for the capacitive elements which, when it is combined with temperature information for the fluid, makes it possible to distinguish the solid state from the liquid state of the medium, independently for each capacitive element.

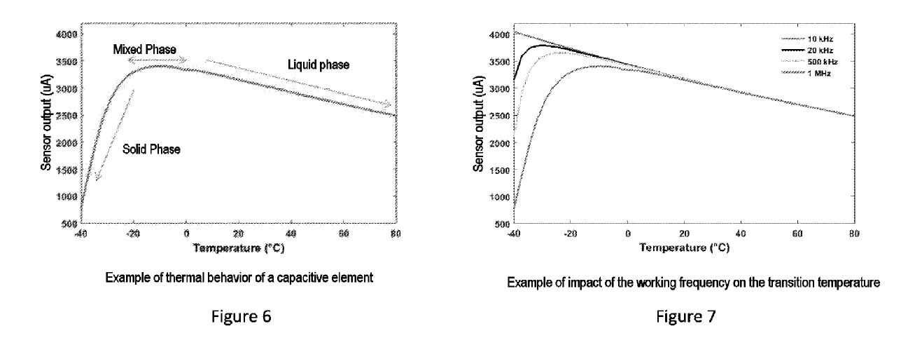

This thermal model is a function of the capacitance of the fluid contained in the tank, i.e. the dielectric constant of this fluid, measured by the capacitive elements of the sensor, the dielectric constant of a fluid varying greatly with the temperature. The dielectric constant of a medium follows a behavior called “dielectric anomaly” which includes three separate phases, as is shown in FIG. 6. The first phase, also called the mixed phase, is located around the transition temperature of the fluid and defines the passage of the fluid from a liquid state to a solid state (and vice versa). This phase therefore corresponds to a phase in which the fluid is a liquid and solid mixture. The second phase, called the solid phase, is located upstream of the transition temperature and corresponds to the phase during which the fluid is solely in the solid state. The third, called the liquid phase, is located downstream of the transition temperature and corresponds to the phase during which the fluid is solely in the liquid state.

However, the occurrence of such behavior of the capacitive elements is a function of the working frequency applied to the capacitive elements, i.e. the frequency at which the capacitive elements are excited. Indeed, the closer the working frequency applied to the capacitive elements is to the relaxation frequency of the medium, the more certain the transition temperature is located in the mixed phase. By contrast, when the working frequency is distanced from the relaxation frequency of the medium, the mixed phase can be shifted upstream of the transition temperature, the thermal behavior of the capacitive elements becoming extremely exponential, as is shown in FIG. 7 for a given fluid. In an extreme situation, the working frequency is extremely distanced from the relaxation frequency of the fluid, the consequence of which is the disappearance of the mixed phase in the thermal behavior of the capacitive elements. In such an example, the thermal behavior of the capacitive elements becomes exponential and it is impossible to directly distinguish the state of the fluid. However, the temperature can give an indication as to the state of the fluid.

In the other situations, the thermal model established on the basis of the thermal behavior of the capacitive elements and of the working frequency makes it possible, with information on the temperature of the fluid, to distinguish the solid state from the liquid state of a fluid.

Consequently, thanks to the plurality of capacitive elements present on the sensor and to the independence thereof with respect to one another, it is possible to distinguish the different states of the fluid, and the location of the states within the tank. Such a distinction makes it possible to establish heating strategies that are particularly suitable depending on the state of the fluid. For example, following the actuation of one or more heaters with the aim of thawing the entirely frozen fluid contained in the tank, it is possible to stop these heaters from operating, as soon as a predetermined quantity of fluid in the liquid state is available. This quantity can be, for example, the minimum quantity of fluid to be provided to the injector. It is therefore possible to avoid overconsumption due to the operation of the heaters when this is not necessary.

Advantageously, the liquid level detecting system of the invention comprises a processing unit configured to perform the step(s) for determining the state of the fluid for all of the tank levels with which a capacitive element of the sensor is associated. The processing unit is also configured to implement an associated heating strategy.

Advantageously, the system according to the invention further comprises at least one heater arranged to heat the fluid contained in the tank when the heating strategy implemented by the processing unit requires it.

In low-temperature conditions, the fluid within the tank is in the solid state (frozen). Heaters are thus activated in order to thaw some of the fluid which passes to the liquid state and can therefore be sent to the injector. However, sometimes one or more air pockets, also called cavities, occur, particularly when the quantity of fluid to be injected is greater than the quantity of fluid in the available liquid state. Consequently, the possibility of independently detecting the state of the fluid at various levels of the tank, thanks to the capacitive elements, makes it possible to avoid liquid level detections which do not represent the fluid actually present in the tank.

1: A method for detecting the level of a fluid in a tank by means of a capacitive sensor, the sensor comprising a column of capacitive elements, each capacitive element being associated with a given level in the tank, the method comprising the following steps consisting in, for each capacitive element:
obtaining a value representing the capacitance of the capacitive element;
obtaining a compensation value as a function of temperature information;
calculating a compensated value from the value representing the capacitance of the capacitive element and from the compensation value;
detecting the presence of the fluid at the level associated with the capacitive element, by comparing the compensated value with a predetermined detection threshold.

2: The method as claimed in claim 1, wherein the sensor comprises at least one thermistor that can provide said temperature information.

3: The method as claimed in claim 1, comprising the following steps consisting in, for a current capacitive element at a current level and a following higher capacitive element at a following higher level:
calculating a value difference between the value representing the capacitance of the current capacitive element and the value representing the capacitance of the following higher capacitive element;
using said calculated value difference in order to calculate said compensated value.

4: The method as claimed in claim 3, comprising:
detecting the presence of a temperature gradient along the sensor and determining a compensation coefficient as a function of said temperature information;
calculating a compensated value difference by applying the compensation coefficient to said calculated value difference;
using said compensated value difference in order to calculate said compensated value.

5: The method as claimed in claim 1, comprising:
detecting an event indicating a need to adjust said detection threshold as a function of the value representing the capacitance of the capacitive element and a predetermined count error tolerance;
adjusting said detection threshold with the value representing the capacitance of the capacitive element.

6: A system for detecting the level of a fluid in a tank comprising:
a capacitive sensor, the sensor comprising a column of capacitive elements, each capacitive element being associated with a given level in the tank;
a processing unit configured to carry out the following steps, for each capacitive element:
obtaining a value representing the capacitance of the capacitive element;
obtaining a compensation value as a function of temperature information;
calculating a compensated value from the value representing the capacitance of the capacitive element and from the compensation value;
detecting the presence of the fluid at the level associated with the capacitive element, by comparing the compensated value with a predetermined detection threshold.
